(19) United States
(12) Patent Application Publication
(10) Pub. No.: US 2026/0093997 A1
(43) Pub. Date: Apr. 2, 2026

(54) SYSTEMS AND METHODS FOR GENERATIVE LANGUAGE MODEL REASONING PROCESS OPTIMIZATION

(71) Applicant: Salesforce, Inc., San Francisco, CA (US)

(72) Inventors: Haolin Chen, San Francisco, CA (US); Yihao Feng, Austin, TX (US); Akshara Prabhakar, San Francisco, CA (US); Zuxin Liu, San Francisco, CA (US); Weiran Yao, Mountain View, CA (US); Ricky Ho, San Francisco, CA (US); Lik Mui, San Francisco, CA (US); Silvio Savarese, Palo Alto, CA (US); Huan Wang, Palo Alto, CA (US); Caiming Xiong, Menlo Park, CA (US)

(21) Appl. No.: 19/043,056

(22) Filed: Jan. 31, 2025

Related U.S. Application Data
(60) Provisional application No. 63/701,309, filed on Sep. 30, 2024.

(51) Int. Cl. G06N 3/092; G06N 3/0475

(52) U.S. Cl. CPC G06N 3/092; G06N 3/0475

(57) ABSTRACT

A system, method, and computer program product for training a generative language model (GLM) is provided. A plurality of sampled rationales for various question-answer pairs are generated using the GLM. A gradient estimate of parameters of neurons in the GLM is determined based on these sampled rationales to maximize the learning objective of the GLM. The parameters of the GLM are modified using the gradient estimate over multiple iterations, ultimately providing a trained GLM.

### CROSS-REFERENCE TO RELATED APPLICATION

This application is a nonprovisional of and claims priority under 35 U.S.C. 119 to U.S. Provisional Application No. 63/701,309 filed Sep. 30, 2024, which is hereby expressly incorporated by reference herein in its entirety.

### TECHNICAL FIELD

The embodiments relate generally to machine learning systems for generative language model (GLM) training, and more specifically to GLM reasoning process optimization.

### BACKGROUND

AI conversation agents, commonly known as chatbots or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI conversation agents can assist with product recommendations, order tracking, and personalized shopping experiences. In information technology (IT) support, these agents can guide users through troubleshooting steps, helping them resolve software and hardware issues. Specifically for network hazards, AI conversation agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output, such as in the form of a text response, or a series of actions to complete a complex task, such as network issue troubleshooting, etc. Such a generative language model receives a natural language input from the AI agents in the form of a sequence of tokens, and in turn generates a predicted distribution over a token space conditioned on the input sequence. Generated output tokens, over time, may in turn form the text response or actions for completing the task.

The development of generative language models, including large language models, with enhanced reasoning capabilities has emerged as a crucial area of research. Despite their impressive advances, the inherent next-token prediction mechanism of these models makes it challenging for them to solve complex problems requiring multiple reasoning steps. For instance, generative language models often struggle to directly provide accurate solutions to mathematical problems or even simple puzzles, like counting specific letters in a word. Consequently, various prompting strategies that guide these models to generate sequences of tokens that build a step-by-step progression toward an answer have been explored.

Improving the reasoning capabilities of generative language models during a training phase remains challenging for several reasons. First, there is a scarcity of high-quality reasoning data for complex problems, limiting the applicability of traditional supervised fine-tuning approaches. Second, even when such data is available, supervised fine-tuning on deterministic reasoning paths may result in a lack of diversity in problem-solving strategies, potentially causing over-confidence issues and performance degradation, especially in domains needing multiple valid approaches, such as mathematical proofs and coding. Third, improving reasoning through reinforcement learning from human feedback presents its own challenges. Developing a reward model that accurately evaluates the quality and validity of reasoning paths is a formidable task, susceptible to distribution shifts and biased evaluations.

Accordingly, there is a need for improving reasoning capabilities of generative language models during the training phase.

### BRIEF DESCRIPTION OF THE DRAWINGS

FIGS. 1A-1C are simplified diagrams illustrating a generative language model (GLM) training framework, according to some embodiments.

FIG. 2A is a simplified diagram illustrating a computing device implementing the GLM training framework described in FIGS. 1A-1C, according to some embodiments.

FIG. 2B is a simplified diagram illustrating a neural network structure, according to some embodiments.

FIG. 3 is a simplified block diagram of a networked system suitable for implementing the GLM training framework described in FIGS. 1A-2B and other embodiments described herein.

FIG. 4 is a diagram illustrating an improvement of a generative language model trained using a GLM training framework, according to some embodiments.

FIG. 5 is a diagram of a pseudo-code for training a generative language model using a GLM training framework, according to some embodiments.

FIG. 6 is an example logic flow diagram illustrating a method based on the framework shown in FIGS. 1A-5, according to some embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “large language model” (LLM) may refer to a neural network based deep learning system designed to understand and generate human languages. An LLM may be an example of a generative language model (GLM). In some instances, LLM (and GLM) may adopt a Transformer architecture that often entails a significant amount of parameters (neural network weights) and computational complexity. For example, GLM and/or LLM such as Generative Pre-trained Transformer (GPT) 3 has 175 billion parameters, Text-to-Text Transfer Transformers (T5) has around 11 billion parameters. An GLM and/or LLM may comprise an architecture of mixed software and/or hardware, e.g., including an application-specific integrated circuit (ASIC) such as a Tensor Processing Unit (TPU).

In some embodiments, a GLM may be unable to generate a correct answer to a natural language question. To improve response accuracy of a GLM, prompt-based reasoning methods like Chain-of-Thought (CoT) may be used. Conventional techniques focus on the design of these reasoning methods. However, without a formulation of the reasoning process itself, it remains unclear how the GLM may be optimized using reasoning capabilities.

Embodiments are directed to systems and methods for GLM training for improved GLM reasoning capabilities. Embodiments include a GLM training framework that optimizes GLM reasoning capabilities without reward model training or external feedback. The GLM training framework described herein improves reasoning by sampling multiple rationales from the GLM, rewarding those that generate the correct responses, and reducing the lengths of rationales.

Embodiments described herein provide a number of benefits. For example, as compared with alternative GLM training techniques across logical reasoning, mathematics, and planning tasks, embodiments described herein achieve superior reasoning performance. Specifically, the improved responses increase the effectiveness of the GLM in various use cases. For example, as integrated into an AI agent system, the improved GLM performance allows for more reliable AI agent behaviors. The improved reliability further allows for the GLM to be used in multi-step reasoning problems. Therefore, with improved performance on reasoning tasks, neural network technology in training GLMs for AI agents, mathematical reasoning, code generation, chat agents, question answering, multi-step reasoning, and other tasks is improved.

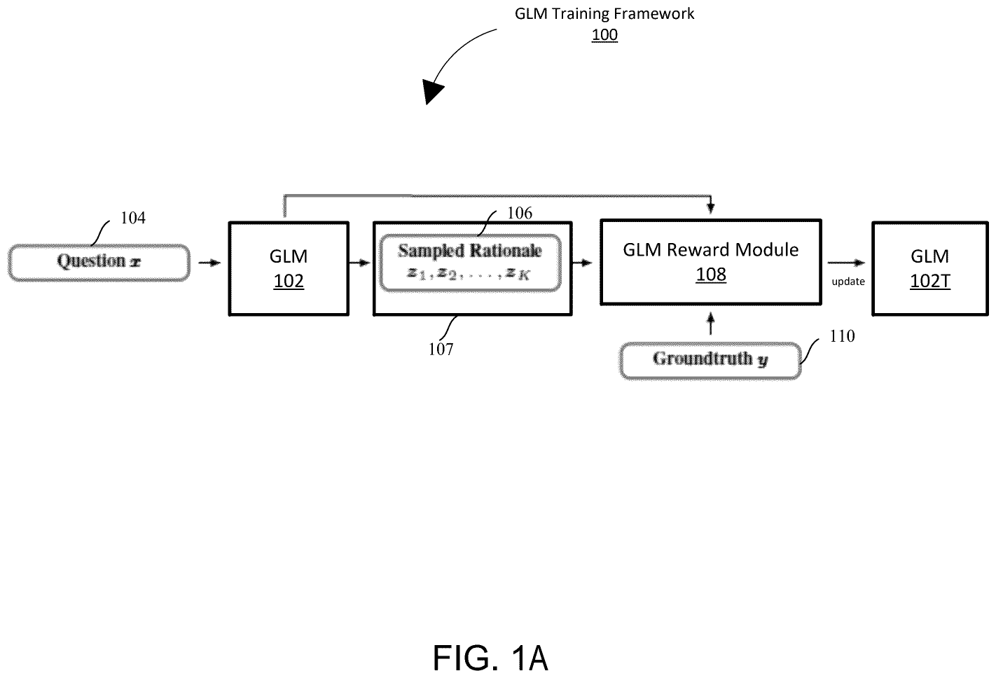

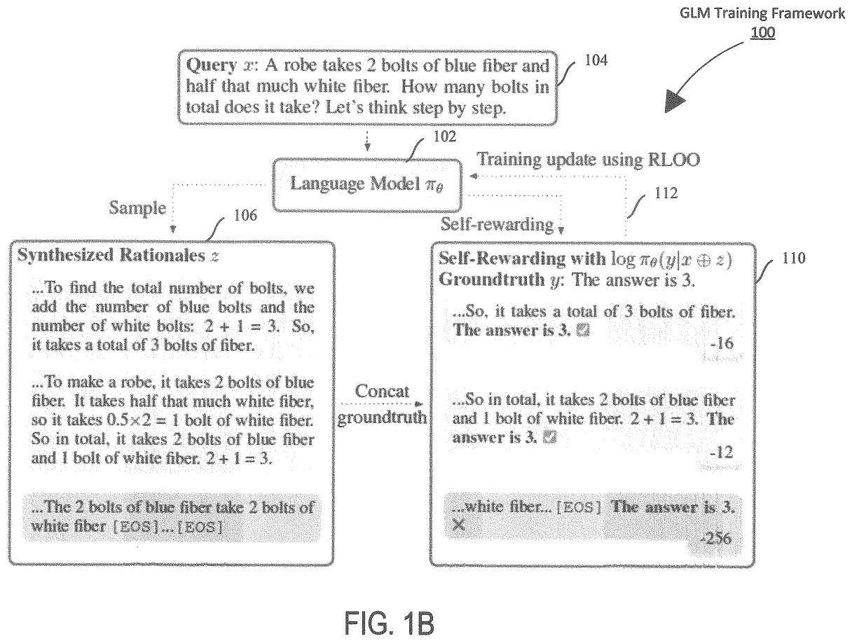

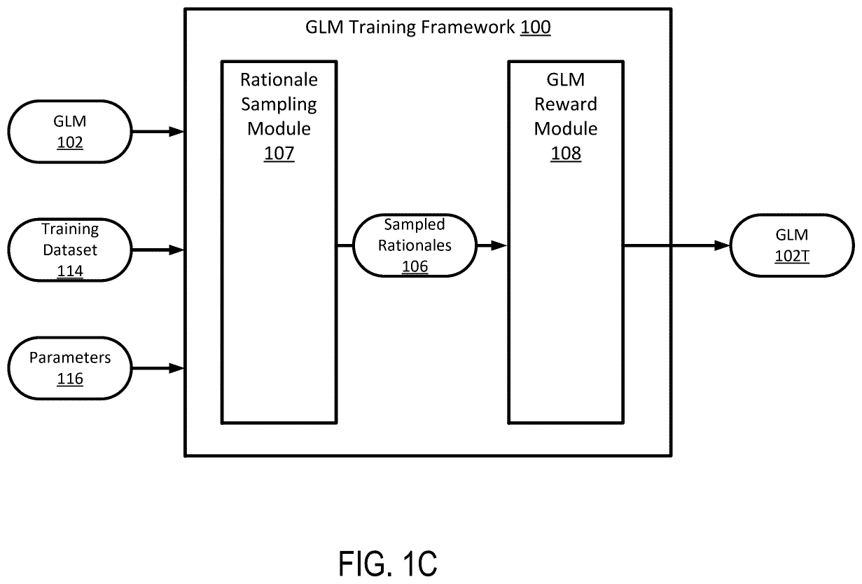

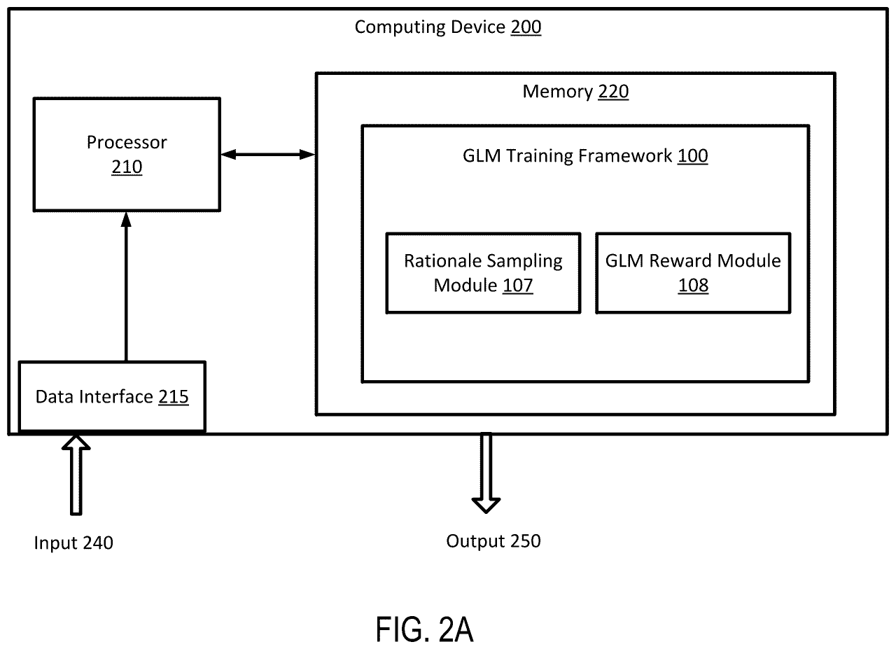

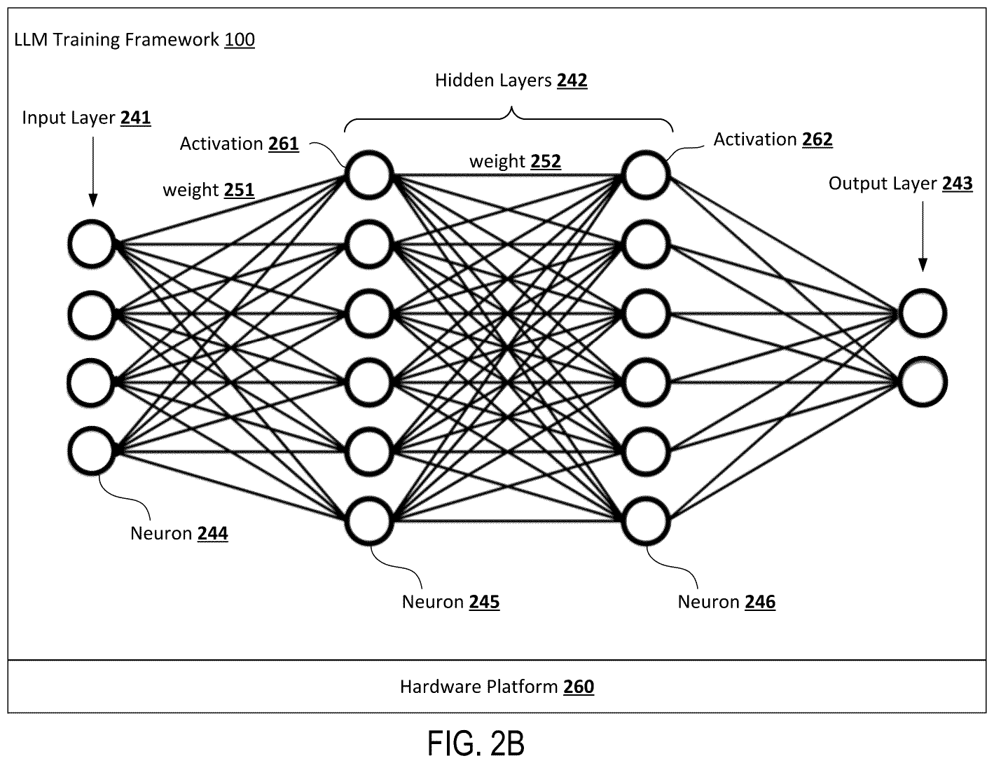

FIGS. 1A and 1B are simplified diagram illustrating training of a GLM with a GLM training framework, according to some embodiments. A GLM training framework 100 receives a generative language model (GLM) 102 (also referred to as language model ne, where π is the GLM 102 and θ are parameters or neural network weights of the GLM 102). GLM 102 may be implemented using an example neural network discussed in FIG. 2B. In some instances, GLM 102 may be a large language model (LLM) and its variants. GLM 102 is designed to understand, generate, and manipulate human language, and can perform a variety of tasks including translation, summarization, question answering, mathematical computation, text generation, code generation, etc.

GLM training framework 100 may train GLM 102 on question-answer pairs and reasoning rationales corresponding to the question. GLM 102 may receive a question 104 (such as question (x) in FIG. 1A) and generate multiple sampled rationales 106 (rationales z) for generating an answer to question 104. Question 104 may be a question in a natural language. FIG. 1B illustrates an example question 104, which may be “A robe takes 2 bolts of blue fiber and half that much white fiber. How many bolts in total does it take?Let's think step by step.” FIG. 1B also illustrates multiple sampled rationales 106 that GLM 102 generated while determining an answer. In some instances, multiple reasoning rationales may be generated by GLM 102 by setting a temperature parameter of the GLM 102 to a value greater than zero, thus allowing for different outputs based on the same input. In some instances, reasoning rationales may also include or be concatenated with a generated outputs y (e.g., an answer to the question). A rationale sampling module 107 may sample a of subset of reasoning rationales. The subset of reasoning rationales may be referred to as sampled rationales 106 or reasoning rationales z.

GLM training framework 100 may include a GLM reward module 108. GLM reward module 108 may receive ground truth output 110 and concatenate the ground truth output 110 to sampled rationales 106 (reasoning rationales z). For example, as shown in FIG. 1B, GLM training framework 100 may concatenate sampled rationales 106 (reasoning rationales z) with the ground truth output 110, which is “The answer is 3.” GLM reward module 108 may then compute a score that represents the likelihood of GLM 102 generating output y that is ground truth output 110 after observing question 104 (question (x)) and sampled rationales 106 (reasoning rationales z).

GLM training framework 100 may train GLM 102 by updating parameters θ using the scores for multiple questions 104 in a training dataset. The training may continue over multiple iterations until parameters θ are optimized to meet a learning objective. In some instances, an GLM reward module 108 may train GLM 102 via backpropagation according to an objective function, optimizing the reasoning. In some embodiments, GLM reward module 108 may compute an average gradient over several sampled rationales and update the some or all parameters θ based on the average gradient. GLM training framework 100 may enter an iterative process where it continues to identify sampled rationales 106 of GLM 102 using rationale sampling module 107, computes the average gradient over the sampled rationales 106 and update some or all parameters θ of the GLM 102. The process then repeat during the next iteration using the updated GLM 102. The iterations may continue until GLM training framework 100 generates a trained GLM 102, referred to as GLM 102T.

The embodiments above illustrate how GLM training framework 100 may optimize the sampled rationales 106 without external feedback. To do so, GLM training framework 100 may introduce an objective for optimizing the sampled rationales 106 from a variational perspective of GLM training. GLM training framework 100 may then derive a gradient estimation for the new objective. GLM training framework 100 may then implement a sampling procedure together with reward shaping.

FIG. 1C is another diagram of a GLM training framework, according to some embodiments. GLM training framework 100 may receive GLM 102 that may be trained, parameters 116 for training GLM 102, and a training dataset 114. Parameters 116 may include a learning rate η, a KL penalty factor β, number of sampled rationales K for each question, a maximum generation length L of each sampled rationale, a sampled temperature T, a number of epochs M corresponding to iterations for training GLM 102, among others, each of which is discussed below. Training dataset 114 may be a golden dataset

$${𝒟}_{Gold} := \{ ( {x}_{i} , {y}_{i} ) \} \begin{matrix}N \\ i = 1\end{matrix}$$

consisting of N question and answer pairs (where N is an integer). In some instances, each pair may be represented as (x,y) where x is a question and y is a correct answer to the question.

A standard finetuning procedure to fit the GLM 102 (model π_{θ}) to the dataset [symbol] _{Gold} may be described by likelihood maximization:

$$\frac{max}{θ} {𝔼}_{( x , y ) ∼ {D}_{Gold} [ log {π}_{θ} ( y \vert x ) ]} \qquad ( 1 )$$

where θ are the parameters of GLM 102 (model π_{θ}) that are optimized. The parameters may be weights of the nodes or neurons in GLM 102 that are further discussed in FIG. 2B. In some instances, GLM training framework 100 may optimize GLM 102 (model π_{θ}) by sampling reasoning rationales. For example, rationale sampling module 107 may sample sampled rationales 106 from possible reasoning rationales generated by GLM 102 while being trained on training dataset 114. The sampled rationales 106 are reasoning rationales z. The rationale sampling module 107 may be referred to as q(z|x). In some instances, rationale sampling module 107 may determine sampled rationales 106 by optimizing the lower bound as follows:

$$\begin{matrix}log {π}_{θ} ( y \vert x ) = log \int {π}_{θ} ( y \vert x ⊕ z ) {π}_{0} ( z \vert x ) dz \\ = log \int {π}_{θ} ( y \vert x ⊕ z ) \frac{q ( z \vert x )}{q ( z \vert x )} {π}_{0} ( z \vert x ) dz \\ \geq {max}_{q ( z \vert x )} {𝔼}_{q ( z \vert x )} [ log {π}_{θ} ( y \vert x ⊕ z ) ] - {D}_{KL} [ q ( z \vert x ) \vert \vert {π}_{0} ( z \vert x ) ]\end{matrix} \qquad ( 2 )$$

where model π₀ is an original GLM 102 that regularizes the rationale sampling module 107 (q(z|x)) and the lower bound is achieved via Jensen's inequality. GLM training framework 100 may learn and optimize q(z|x) via variational Expectation Maximization (EM) or introduce another parameterized LLM q₀(z|x) and optimize Ø to amortize the cost. Additionally, GLM 102 (model π_{θ}) may also serve as a naive rationale sampling module 107 since wo is an autoregressive LLM.

To reduce computation overhead and better control the sampling of reasoning rationales during training, GLM training framework 100 may limit the maximum token length to L, where L may be a hyperparameter. Further, the reasoning rationale may end either at the EOS token or at the start of a predefined answer template (e.g., “The answer is”), whichever comes first. GLM training framework 100 may truncate sampled rationale z, the question x and/or the answer y to L number of tokens prior to further computation. To encourage GLM training framework 100 to complete its reasoning process within the L tokens or less, GLM training framework 100 may including a penalty for sampled rationales 106 (reasoning rationales z) that may be truncated by the maximum token length L. The truncated sampled rationales may be identified as those that do not have the EOS token or the predefined answer template. The penalty may encourage the generation of rationales that fit within the specified token limit. Instead of a constant penalty, an adaptive penalty may be applied by setting the reward to the average reward of the current batch, multiplied by a constant factor.

Rationale sampling module 107 (q(z|x)) may be GLM 102 (model π₀). In this embodiment, GLM 102 may be trained to generate sampled rationales 106, correct answer y to input question x and a corresponding reasoning rationale. In some instances, the learning objective for training GLM 102 may be defined as follows:

$$\begin{matrix}max \\ θ\end{matrix} J ( θ ) := {𝔼}_{( x , y ) ∼ {D}_{Gold}} [ {𝔼}_{z ∼ {π}_{θ} ( \cdot \vert X )} \frac{[ log {π}_{θ} ( y \vert x ⊕ z ) ]}{{R}_{θ} ( z , y , x )} - {D}_{KL} [ {π}_{θ} ( z \vert x ) \vert \vert {π}_{0} ( z \vert x ) ] ] \qquad ( 3 )$$

where model π₀ is the original GLM 102 prior to optimization and model π₀ is GLM 102T with the parameters θ that are being optimized. Furthermore, the log π_{θ}(y|x⊕z) in Equation (3) may be a reward function R_{θ}(z,y,x) that evaluates the quality of one of the sampled rationales z given the pair (x,y), where x is the input question 104 and y is a ground truth output 110. The reward function R_{θ}(z,y,x) may be GLM reward module 108. As discussed above, reasoning rationale z with a higher likelihood log π_{θ}(y|x⊕z) indicates that it would provide a higher probability for GLM 102 to answer the input question 104 correctly. D_{KL} is a Kullback-Leibler Divergence that is a measure that quantifies a divergence between probability distributions of the original GLM 102 (model wo) and the optimized GLM 102T (model π₀). In Equation (3), D_{KL} ensures that the distribution of the GLM 102 (model π₀) that is being optimized by updating parameters θ is not far from the original GLM 102 (model π₀). Further, by maximizing

$$\begin{matrix}max \\ θ\end{matrix} J ( θ ) ,$$

the log likelihood for producing the correct answer y will be increased.

In some instances, Equation (3) unifies the learning procedure of the rationale sampling module 107 (π_{θ}(z|x)) and the GLM reward module 108 (reward function R_{θ}(z,y,x):=log π_{θ}(y|x (z)). When GLM training framework 100 fixes GLM reward module 108 (R_{θ}(z,y,x)) and optimizes the rationale sampling module 106 (π_{θ}(z|x)), GLM training framework 100 may improve π_{θ}(z|x) on self-generated synthetic reasoning rationale. When GLM training framework 100 fixes rationale sampling module (π_{θ}(z|x)) and optimizes GLM reward module 108 (R_{θ}(z,y,x)), GLM training framework 100 may learn the self-reward function log π_{θ}(y|x⊕z). The procedure can also be considered finetuning optimization given the learned reasoning rationale and question.

To optimize GLM 102 (e.g., by maximizing

$$\begin{matrix}max \\ θ\end{matrix} J ( θ )$$

of Equation (3)), GLM training framework 100 may estimate the gradient ∇_{θ}J(B). In some instances, GLM training framework 100 may estimate the gradient ∇_{θ}J(B) using a REINFORCE Leave-One-Out (RLOO) technique or another reinforcement learning objective and/or a Monte Carlo simulation, both of which are known in the art. GLM training framework 100 may also use the RLOO technique to optimize the GLM reward module 108 (π_{θ}(z|x)) where the lower variances of gradient estimation are achieved by sampled rationales 106 as follows. Suppose GLM training framework 100 receives a set of training data

$${D}_{Gold} := \{ {x}_{i} , {y}_{i} \} \begin{matrix}N \\ i = 1\end{matrix} .$$

GLM training framework 100 may sample K reasoning rationales

$${z}_{1}^{( i )} , {z}_{2}^{( i )} , … , {z}_{K}^{( i )} ∼ {π}_{θ} ( \cdot \vert {x}_{i} )$$

for each question and answer pair (xᵢ|yᵢ). The empirical gradient estimator for ∇_{θ}J(θ) may be expressed as follows:

$${∇}_{θ} \hat{J} ( θ ) := \frac{1}{NK} {\sum }_{i = 1}^{N} {\sum }_{k = 1}^{K} ( {∇}_{θ} log {π}_{θ} ( {z}_{k}^{( i )} \vert {x}_{i} ) \cdot {A}_{k}^{( i )} + {∇}_{θ} log {π}_{θ} ( {y}_{i} \vert {x}_{i} ⊕ {z}_{k}^{( i )} ) ) , \qquad ( 4 )$$

$$with {A}_{k}^{( i )} = r ( {z}_{k}^{( i )} ) - \frac{1}{K - 1} {\sum }_{j \neq k}^{K} r ( {z}_{j}^{( i )} ) ,$$

$$r ( {z}_{k}^{( i )} ) := log {π}_{θ} ( {y}_{i} \vert {x}_{i} ⊕ {z}_{k}^{( i )} ) - β log \frac{{π}_{θ} ( {z}_{k}^{( i )} \vert {x}_{i} )}{{π}_{0} ( {z}_{k}^{( i )} \vert {x}_{i} )}$$

where β≥0 is the coefficient to control the KL penalty. The first gradient term in Equation (4) serves as policy gradient to improve the ability of the GLM wo to generate high-quality reasoning rationales, and log π_{θ}(y|x⊕z) may evaluate the reasoning rationale, which is further used to calculate the advantages. The second gradient term in Equation (4) is the gradient of supervised finetuning loss, which helps the GLM π_{θ} to leverage the reasoning rationales 106 to produce correct answers. The

$${A}_{k}^{( i )}$$

is an advantage parameter that quantifies how one reasoning rationale performs with respect to other reasoning rationales (e.g., the average of the other rationales) in sampled rationales 106 and r is a reward parameter. As illustrated above, the reward r may be a probability for generating a correct answer y to input question x given the one rationale that is regularized by the KL divergence penalty, and β is a penalty factor that is a hyperparameter that may be preset or configured to control the sensitivity of the KL divergence on the reward r.

### Computer and Network Environment

FIG. 2A is a simplified diagram illustrating a computing device implementing the GLM training framework described in FIG. 1, according to one embodiment described herein. As shown in FIG. 2A, computing device 200 includes a processor 210 coupled to memory 220. Operation of computing device 200 is controlled by processor 210. And although computing device 200 is shown with only one processor 210, it is understood that processor 210 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 200. Computing device 200 may be implemented as a stand-alone subsystem, as a board added to a computing device, and/or as a virtual machine.

Memory 220 may be used to store software executed by computing device 200 and/or one or more data structures used during operation of computing device 200. Memory 220 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 210 and/or memory 220 may be arranged in any suitable physical arrangement. In some embodiments, processor 210 and/or memory 220 may be implemented on a same board, in a same package (e.g., system-in-package), on a same chip (e.g., system-on-chip), and/or the like. In some embodiments, processor 210 and/or memory 220 may include distributed, virtualized, and/or containerized computing resources. Consistent with such embodiments, processor 210 and/or memory 220 may be located in one or more data centers and/or cloud computing facilities.

In another embodiment, processor 210 may comprise multiple microprocessors and/or memory 220 may comprise multiple registers and/or other memory elements such that processor 210 and/or memory 220 may be arranged in the form of a hardware-based neural network, as further described in FIG. 2B.

In some examples, memory 220 may include non-transitory, tangible, machine readable media that includes executable code that when run by one or more processors (e.g., processor 210) may cause the one or more processors to perform the methods described in further detail herein. For example, as shown, memory 220 includes instructions for GLM training framework 100 that may be used to implement and/or emulate the systems and models, and/or to implement any of the methods described further herein. GLM training framework 100 may receive input 240 such as an input training data (e.g., GLM 102, training dataset 114, and parameters 116) via the data interface 215 and generate an output 250 which may be a trained GLM 102T, or a trained GLM set of parameters. As discussed in FIG. 1C, GLM training framework 100 may include rationale sampling module 107 and GLM reward module 108.

In some examples, memory 220 may also store GLM 102T (not shown). In this embodiment, a trained GLM 102T may receive questions as input 240 and generate answers as output 250.

The data interface 215 may comprise a communication interface, a user interface (such as a voice input interface, a graphical user interface, and/or the like). For example, the computing device 200 may receive the input 240 (such as a training dataset) from a networked database via a communication interface. Alternatively, the computing device 200 may receive the input 240 from a user via the user interface.

Some examples of computing devices, such as computing device 200 may include non-transitory, tangible, machine readable media that include executable code that when run by one or more processors (e.g., processor 210) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 2B is a simplified diagram illustrating the neural network structure implementing the GLM training framework 100 or GLM 102 described in FIG. 2A, according to some embodiments. In some embodiments, the GLM training framework 100 and/or one or more of its modules 107-108 may be implemented at least partially via an artificial neural network structure shown in FIG. 2B. Alternatively, GLM training framework 100 may act on GLM 102 that is implemented as neural network structure. The neural network comprises a computing system that is built on a collection of connected units or nodes, referred to as neurons (e.g., 244, 245, 246). Neurons are often connected by edges, and an adjustable weight (e.g., 251, 252) is often associated with the edge. The neurons are often aggregated into layers such that different layers may perform different transformations on the respective input and output transformed input data onto the next layer.

For example, the neural network architecture may comprise an input layer 241, one or more hidden layers 242 and an output layer 243. Each layer may comprise a plurality of neurons, and neurons between layers are interconnected according to a specific topology of the neural network topology. The input layer 241 receives the input data (e.g., 240 in FIG. 2A), such as a user prompt. The number of nodes (neurons) in the input layer 241 may be determined by the dimensionality of the input data (e.g., the length of a vector of a prompt). Each node in the input layer represents a feature or attribute of the input.

The hidden layers 242 are intermediate layers between the input and output layers of a neural network. It is noted that two hidden layers 242 are shown in FIG. 2B for illustrative purpose only, and any number of hidden layers may be utilized in a neural network structure. Hidden layers 242 may extract and transform the input data through a series of weighted computations and activation functions.

For example, as discussed in FIG. 2A, the GLM training framework 100 receives an input 240, such as GLM 102, and transforms the input into an output 250 of a trained GLM 102T. To perform the transformation, each neuron receives input signals, performs a weighted sum of the inputs according to weights assigned to each connection (e.g., 251, 252), and then applies an activation function (e.g., 261, 262, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like, as well as the embodiments discussed in FIG. 1C. In this way, after a number of hidden layers, input data received at the input layer 241 is transformed into rather different values indicative data characteristics corresponding to a task that the neural network structure has been designed to perform.

The output layer 243 is the final layer of the neural network structure. It produces the network's output or prediction based on the computations performed in the preceding layers (e.g., 241, 242). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the GLM training framework 100, GLM 102, GLM 102T, and/or modules 107-108 may comprise the transformative neural network structure of layers of neurons, and weights and activation functions describing the non-linear transformation at each neuron. Such a neural network structure is often implemented on one or more hardware processors 210, such as a graphics processing unit (GPU).

In one embodiment, the GLM training framework 100 and its modules 107-108, GLM 102, GLM 102T, may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for input tokens to be processed through the multiple layers to generate an output in a Transformer architecture often entail hundreds of teraflops (trillions of floating-point operations) of computation.

In one embodiment, the GLM training framework 100 and its modules 107-108, GLM 102, and/or GLM 102T, may be implemented by hardware, software and/or a combination thereof. For example, the GLM training framework 100 and its modules 107-108, GLM 102, and/or GLM 102T may comprise a specific neural network structure implemented and run on various hardware platforms 260, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 260 used to implement the neural network structure is specifically configured based on factors such as the complexity of the neural network, the scale of the tasks (e.g., training time, input data scale, size of training dataset, etc.), and the desired performance.

In another embodiment, some or all of layers 241, 242, 243 and/or neurons 242, 245, 246, and operations there between such as activations 261, 262, and/or the like, of the GLM training framework 100 and its modules 107-108, GLM 102, and/or GLM 102T may be realized via one or more ASICs. For example, each neuron 242, 245 and 246 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the GLM training framework 100, GLM 102, and/or GLM 102T may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based GLM training framework 100 and one or more of its modules 107-108, GLM 102, and/or GLM 102T may be trained by iteratively updating the underlying parameters (e.g., weights 251, 252, etc., bias parameters and/or coefficients in the activation functions 261, 262 associated with neurons) of the neural network based on a loss. For example, during forward propagation, the training data such as prompts and ground-truth responses (and/or expert-generated responses) are fed into the neural network. The data flows through the network's layers 241, 242, with each layer performing computations based on its weights, biases, and activation functions until the output layer 243 produces the network's output 250. In some embodiments, output layer 243 produces an intermediate output on which the network's output 250 is based.

The output generated by the output layer 243 is compared to the expected output (e.g., a “ground-truth” such as the corresponding response) from the training data, to compute a loss function that measures the discrepancy between the predicted output and the expected output. Given the loss, the negative gradient of the loss function is computed with respect to each weight of each layer individually. Such negative gradient is computed one layer at a time, iteratively backward from the last layer 243 to the input layer 241 of the neural network. These gradients quantify the sensitivity of the network's output to changes in the parameters. The chain rule of calculus is applied to efficiently calculate these gradients by propagating the gradients backward from the output layer 243 to the input layer 241.

In one embodiment, the neural network based GLM training framework 100 and one or more of its modules 107-108, GLM 102, and/or GLM 102T may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

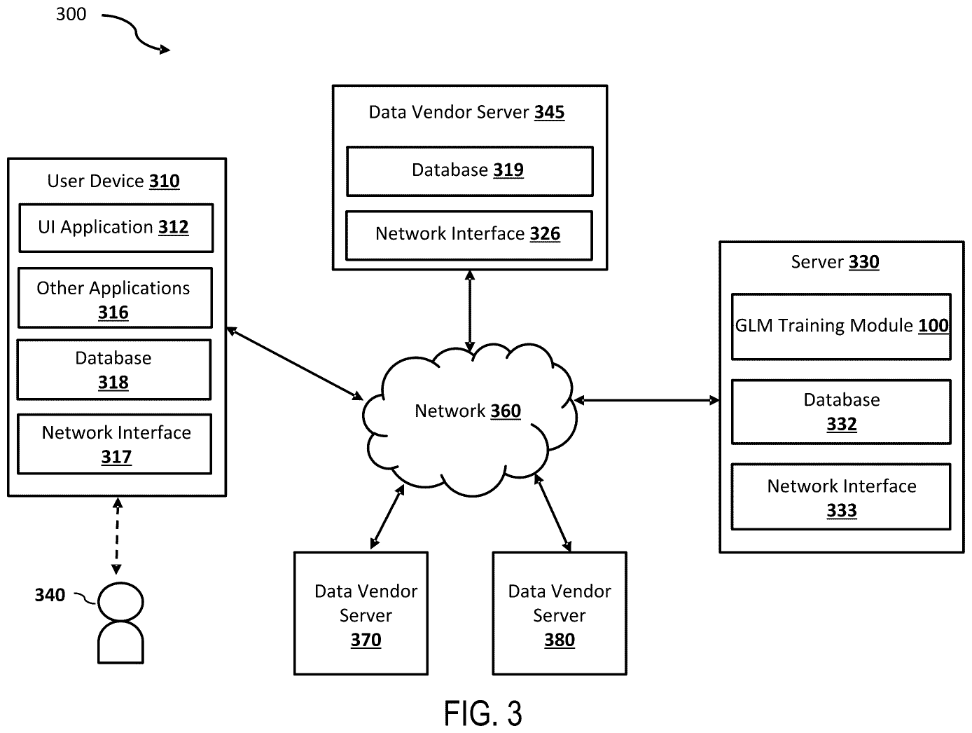

In one embodiment, GLM training framework 100 and its modules 107-108, GLM 102, and/or GLM 102T may be housed at a centralized server (e.g., computing device 200) or one or more distributed servers. For example, one or more of GLM training framework 100 and its modules 107-108, GLM 102, and/or GLM 102T may be housed at external server(s). The different modules may be communicatively coupled by building one or more connections through application programming interfaces (APIs) for each respective module. Additional network environment for the distributed servers hosting different modules and/or submodules may be discussed in FIG. 3.

During a backward pass, parameters of the neural network are updated backwardly from the last layer to the input layer (backpropagating) based on the computed negative gradient using an optimization algorithm to minimize the loss. The backpropagation from the last layer 243 to the input layer 241 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as unseen user prompts.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an GLM and/or LLM may sometimes be carried out by updating the input prompt, e.g., the instruction to teach an GLM and/or LLM how to perform a certain task. For example, while the parameters of the LLM may be frozen, a set of tunable prompt parameters and/or embeddings that are usually appended to an input to the GLM and/or LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an GLM and/or LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in reliable reasoning, neural network technology in training of GLMs and/or LLMs for AI agents, code generation, chat agents, question answering, multi-step reasoning, and others.

FIG. 3 is a simplified block diagram of a networked system 300 suitable for implementing the GLM training framework described in FIGS. 1-2B and other embodiments described herein. In one embodiment, system 300 includes the user device 310 which may be operated by user 340, data vendor servers 345, 370 and 380, server 330, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2A, operating an OS such as a MICROSOFT® OS, a UNIX® OS, a LINUX® OS, or other suitable device and/or server-based OS. It can be appreciated that the devices and/or servers illustrated in FIG. 3 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 310, data vendor servers 345, 370 and 380, and the server 330 may communicate with each other over a network 360. User device 310 may be utilized by a user 340 (e.g., a driver, a system admin, etc.) to access the various features available for user device 310, which may include processes and/or applications associated with the server 330 to receive an output data anomaly report.

User device 310, data vendor server 345, and the server 330 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 360.

User device 310 may be implemented as a communication device that may utilize appropriate hardware and software configured for wired and/or wireless communication with data vendor server 345 and/or the server 330. For example, in one embodiment, user device 310 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 310 of FIG. 3 contains a user interface (UI) application 312, and/or other applications 316, which may correspond to executable processes, procedures, and/or applications with associated hardware. For example, the user device 310 may receive a message indicating a response from the server 330 and display the message via the UI application 312. In other embodiments, user device 310 may include additional or different modules having specialized hardware and/or software as required.

In one embodiment, UI application 312 may communicatively and interactively generate a UI for an AI agent implemented through the GLM training framework 100 (e.g., an LLM agent) at server 330. In at least one embodiment, a user operating user device 310 may enter a user utterance, e.g., via text or audio input, such as a question, uploading a document, and/or the like via the UI application 312. Such user utterance may be sent to server 330, at which GLM training framework 100 may generate a response via the process described in FIGS. 1-2B. The GLM training framework 100 may thus cause a display of a response at UI application 312 and interactively update the display in real time with the user utterance.

In various embodiments, user device 310 includes other applications 316 as may be desired in particular embodiments to provide features to user device 310. For example, other applications 316 may include security applications for implementing client-side security features, programmatic client applications for interfacing with appropriate application programming interfaces (APIs) over network 360, or other types of applications. Other applications 316 may also include communication applications, such as email, texting, voice, social networking, and IM applications that allow a user to send and receive emails, calls, texts, and other notifications through network 360. For example, the other application 316 may be an email or instant messaging application that receives a prediction result message from the server 330. Other applications 316 may include device interfaces and other display modules that may receive input and/or output information. For example, other applications 316 may contain software programs for asset management, executable by a processor, including a graphical user interface (GUI) configured to provide an interface to the user 340 to view generated responses.

User device 310 may further include database 318 stored in a transitory and/or non-transitory memory of user device 310, which may store various applications and data and be utilized during execution of various modules of user device 310. Database 318 may store user profile relating to the user 340, predictions previously viewed or saved by the user 340, historical data received from the server 330, and/or the like. In some embodiments, database 318 may be local to user device 310. However, in other embodiments, database 318 may be external to user device 310 and accessible by user device 310, including cloud storage systems and/or databases that are accessible over network 360.

User device 310 includes at least one network interface component 317 adapted to communicate with data vendor server 345 and/or the server 330. In various embodiments, network interface component 317 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 345 may correspond to a server that hosts database 319 to provide training datasets including prompts and responses to the server 330. The database 319 may be implemented by one or more relational database, distributed databases, cloud databases, and/or the like.

The data vendor server 345 includes at least one network interface component 326 adapted to communicate with user device 310 and/or the server 330. In various embodiments, network interface component 326 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 345 may send asset information from the database 319, via the network interface 326, to the server 330.

The server 330 may be housed with the GLM training framework 100 and its modules 107-108, GLM 102, and/or GLM 102T described in FIGS. 1A-C. In some implementations, GLM training framework 100, and/or GLM 102T may receive data and/or GLM 102 from database 319 at the data vendor server 345 via the network 360 to generate responses. The generated responses may also be sent to the user device 310 for review by the user 340 via the network 360.

The database 332 may be stored in a transitory and/or non-transitory memory of the server 330. In one implementation, the database 332 may store data obtained from the data vendor server 345. In one implementation, the database 332 may store parameters of the GLM training framework 100. In one implementation, the database 332 may store previously generated responses, and the corresponding input feature vectors.

In some embodiments, database 332 may be local to the server 330. However, in other embodiments, database 332 may be external to the server 330 and accessible by the server 330, including cloud storage systems and/or databases that are accessible over network 360.

The server 330 includes at least one network interface component 333 adapted to communicate with user device 310 and/or data vendor servers 345, 370 or 380 over network 360. In various embodiments, network interface component 333 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 360 may be implemented as a single network or a combination of multiple networks. For example, in various embodiments, network 360 may include the Internet or one or more intranets, landline networks, wireless networks, and/or other appropriate types of networks. Thus, network 360 may correspond to small scale communication networks, such as a private or local area network, or a larger scale network, such as a wide area network or the Internet, accessible by the various components of system 300.

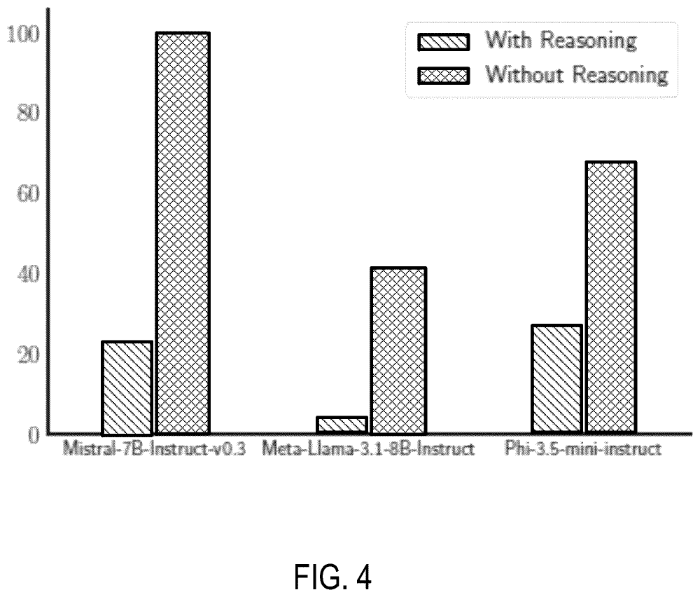

FIG. 4 is a diagram illustrating an improvement of a generative language model using GLM training framework 100, according to some embodiments. FIG. 4 illustrates a negative log probability of the correct answers generated by three different LLMs on the same dataset, e.g., the GSM8K dataset. The dataset may be a mathematical dataset in which the questions in a natural language cause the GLMs to generate a mathematical answer. The three GLMs may be LLMs such as Mistral-7B-Instruct-v0.3, Meta-LLaMA-3.1-8B-Instruct, and Phi-3.5-mini-instruct. As illustrated in the diagram in FIG. 4, when three GLMs are conditioned on the reasoning rationales discussed in FIGS. 1A-C using GLM training framework 100, the probability of the GLM models generating a correct answer is larger than when the three GLMs are not conditioned on the reasoning rationales.

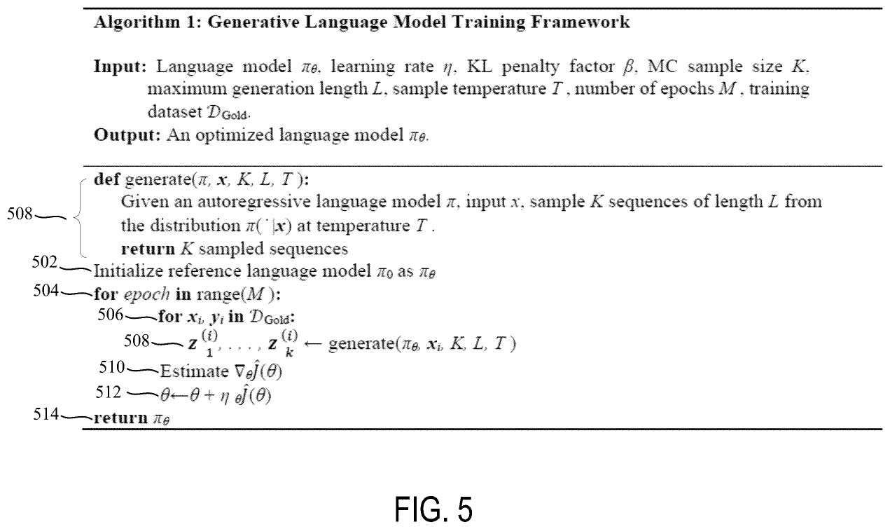

FIG. 5 is a diagram of a pseudo-code for training a generative language model using the generative language model training framework, according to some embodiments. As illustrated in FIG. 5, the input into GLM training framework 100 includes an untrained GLM 102 (model π_{θ}) and parameters 116, which may be a learning rate η, a KL penalty factor β, number of sampled rationales K for each question, a maximum generation length L of each sampled rationale, a sample temperature T, a number of epochs M for training GLM 102, and the training dataset [symbol] _{Gold}. The output of the GLM training framework 100 is the trained or optimized GLM 102T (model π_{θ}).

As illustrated in step 502 in FIG. 5, GLM training framework 100 initializes the original GLM 102 to (model π₀) prior to training. In this way, parameters θ of the untrained GLM 102 are saved before being updated. GLM 102 may then be used as a reference model as discussed in FIG. 1C. Next, in step 504, GLM training framework 100 enters into an iterative training cycle for M number of epochs. The cycle continues until M number of epochs are reached, at which point GLM 102 is deemed trained as GLM 102T.

Steps 506-512 discuss each step in the iterative cycle. In step 506 a question-answer pair (xᵢ, yᵢ) is selected from the training dataset [symbol] _{Gold}. At step 508, for the selected question-answer pair (xᵢ,yᵢ), a K number of sampled rationales 106 are generated. Step 508 is further expanded upon using the generate function, where given a question xᵢ multiple reasoning rationales are generated from distribution π(′|x) at temperature T. The number of reasoning rationales may be capped at K number of sampled rationes 106 (reasoning rationale

$${z}^{( i )} = {z}_{1}^{( i )} , … , {z}_{k}^{( i )} ) .$$

Further, step 508 may repeat for multiple (xᵢ, yᵢ) pairs in training dataset [symbol] _{Gold} as i is being incremented at each iteration until sampled rationales 106 are generated from some or all pairs (xᵢ, yᵢ). At step 510, a gradient is estimated as shown in Equation (4) using the sampled rationales 106 (reasoning rationales z) for multiple sampled pairs (xᵢ, yᵢ). At step 512, GLM 102 is optimized by modifying the values of the parameters θ to maximize

$$\begin{matrix}max \\ θ\end{matrix} J ( θ )$$

as discussed in Equation (3). Steps 506-512 then repeat for the next iteration of the epoch. Upon completion of the step 504, GLM training framework 100 outputs a trained GLM 102T at step 514.

### Example Workflow

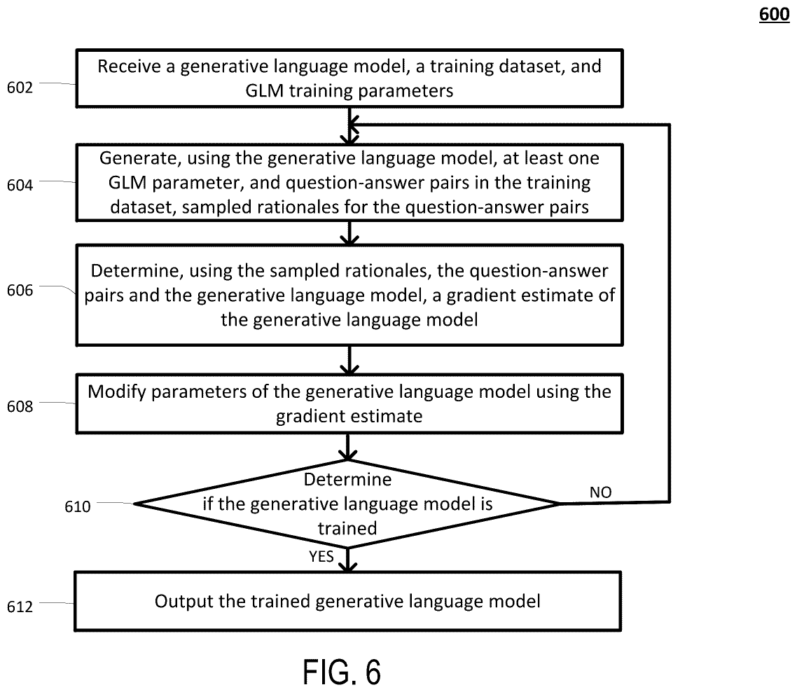

FIG. 6 is an example logic flow diagram illustrating a method 600 based on the framework shown in FIGS. 1-5, according to some embodiments described herein. One or more of the processes of method 600 may be implemented, at least in part, in the form of executable code stored on non-transitory, tangible, machine-readable media that when run by one or more processors may cause the one or more processors to perform one or more of the processes. In some embodiments, method 600 corresponds to the operation of the GLM training framework 100 (e.g., FIGS. 1-5) that trains GLM 102.

As illustrated, the method 600 includes a number of enumerated operations, but aspects of the method 600 may include additional operations before, after, and in between the enumerated operations. In some aspects, one or more of the enumerated operations may be omitted or performed in a different order.

At operation 602, a GLM, a training dataset, and parameters for training the GLM are received. For example, GLM training framework 100 may receive GLM 102, training dataset 114, and parameters 116.

At operation 604, sampled rationales are generated. For example, GLM 102 may generate sampled rationales 106 (reasoning rationales z) for one or more question-answer pairs (x,y) in the training dataset. The number of sampled rationales 106 may depend on a parameter K and temperature T in parameters 116. Operation 604 may repeat for multiple question-answer pairs (x,y) in training dataset 114.

At operation 606, a gradient estimate of the generative language model is determined. For example, GLM training framework 100 may determine a gradient of the parameters of GLM 102 based on the sampled rationales 106 (reasoning rationales z) for multiple question-answer pairs (x,y), question-answer pairs (x,y), and GLM 102. In some instances, the answer y may be appended to corresponding sampled rationales 106. Further, the sampled rationales 106 with a size greater than parameter L in parameters 116 may be truncated to size L and penalized. The gradient estimate is determined such that the learning objective is maximized. Operation 606 is further discussed with reference to FIGS. 1A-1C above.

At operation 608, parameters of the GLM are modified. For example, GLM training framework 100 may modify the parameters of GLM 102 using the gradient estimate determined in operation 606 to generate a version of GLM 102 with the modified parameters.

At operation 610, a determination is made whether the GLM 102 is trained. For example, GLM training framework 100 may determine whether the training has continued over a number of epochs set by parameter M in parameters 116. If so, method 600 proceeds to operation 612. If not, method 600 proceeds to operation 604 where new sampled rationales 106 are generated from the GLM 102 with the modified parameters.

At operation 612, a trained GLM is provided. For example, GLM training framework 100 may provide a trained GLM 102T with the trained parameters. Following operation 612, GLM 102T may inter into an inference stage. At the inference stage, GLM 102T may receive a question in a natural language and generate an answer to the question. As discussed above, the question may be a query, a request to generate source code, perform a series of tasks, a mathematical question, and the like.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method for training a generative language model (GLM), the method comprising:
generating, using the GLM, a plurality of sampled rationales for a plurality of question-answer pairs in a training dataset;
determining, using the plurality of sampled rationales, a gradient estimate of parameters of neurons in the GLM, wherein the gradient estimate maximizes a learning objective of the GLM;
modifying the parameters of the GLM using the gradient estimate; and
providing a trained GLM with the modified parameters.

2. The method of claim 1, further comprising:
repeating the determining and the modifying over multiple iterations; and
generating the trained GLM upon completion of the multiple iterations.

3. The method of claim 1, further comprising:
determining rewards corresponding to the plurality of sampled rationales, wherein the rewards quantify whether the plurality of sampled rationales and questions in the question-answer pairs would cause the GLM to generate answers in the questions in the question-answer pairs; and
maximizing the learning objective of the GLM using the rewards.

4. The method of claim 3, further comprising:
determining a first probability of a first distribution of the parameters of the GLM prior to modifying the parameters;
determining a second probability of a second distribution of the parameters of the GLM after modifying the parameters;
determining divergence of the parameters based on the first probability and the second probability; and
maximizing the learning objective based on the divergence.

5. The method of claim 1, further comprising:
constraining the plurality of sampled rationales to a predetermined length, wherein the constraining further comprising truncating at least one rationale in the plurality of sampled rationales that exceeds the predetermined length.

6. The method of claim 1, wherein determining the gradient estimate further comprises:
determining a first gradient configured to improve the GLM generating a plurality of second sampled rationales during a subsequent iteration; and
determining a second gradient configured to cause the GLM to generate correct answers to questions in the question-answer pairs during the subsequent iteration; and
determining the gradient estimate using the first gradient and the second gradient.

7. The method of claim 6, wherein determining the first gradient further comprises:
determining an advantage parameter that quantifies how a sampled rationale in a subset of sampled rationales corresponding to a question-answer pair determines a corresponding answer to a question with respect other sampled rationales in the subset of rationales; and
adjusting the first gradient based on the advantage parameter.

8. The method of claim 1, wherein the GLM is at least one large language model.

9. A system for training a generative language model (GLM), the system comprising:
at least one processor; and
at least one memory coupled to at least one processor and configured to store instructions that cause the at least one processor to perform operations, the operations comprising:
generating, using the GLM, a plurality of sampled rationales for a plurality of question-answer pairs;
determining, using the plurality of sampled rationales, a gradient estimate of parameters of neurons in the GLM, wherein the gradient estimate maximizes a learning objective of the GLM;
modifying the parameters of the GLM using the gradient estimate; and
providing a trained GLM with the modified parameters.

10. The system of claim 9, wherein the operations further comprise:
repeating the determining and the modifying over multiple iterations; and
generating the trained GLM upon completion of the multiple iterations.

11. The system of claim 9, wherein the operations further comprise:
determining rewards corresponding to the plurality of sampled rationales, wherein the rewards quantify whether the plurality of sampled rationales and questions in question-answer pairs would cause the GLM to generate corresponding answers; and
maximizing the learning objective of the GLM using the rewards.

12. The system of claim 9, wherein the operations further comprise:
determining a first probability of a first distribution of the parameters of the GLM prior to modifying the parameters;
determining a second probability of a second distribution of the parameters of the GLM after modifying the parameters;
determining divergence of the parameters using the first probability and the second probability; and
maximizing the learning objective based on the divergence.

13. The system of claim 9, wherein the operations further comprise:
constraining the plurality of sampled rationales to a predetermined length, wherein the constraining further comprising truncating at least one rationale in the plurality of sampled rationales that exceeds the predetermined length.

14. The system of claim 9, wherein to determine the gradient estimate, the operations further comprise:
determining a first gradient configured to improve the GLM generating a plurality of second sampled rationales during a subsequent iteration; and
determining a second gradient configured to cause the GLM to generate correct answers to questions in the question-answer pairs during the subsequent iteration; and
determining the gradient estimate using the first gradient and the second gradient.

15. The system of claim 14, wherein to determine the first gradient, the operations further comprise:
determining an advantage parameter that is based on how a sampling rationale in a subset of sampled rationales corresponding to a question-answer pair determines a corresponding answer to a question with respect other sampled rationales in the subset of rationales; and
adjusting the first gradient based on the advantage parameter.

16. The system of claim 9, wherein the GLM is at least one large language model.

17. A non-transitory computer readable medium, having instructions stored thereon, that when executed by a processor, cause the processor to train a generative language model (GLM), the operations comprising:
generating, using the GLM, a plurality of sampled rationales for a plurality of question-answer pairs;
determining, using the plurality of sampled rationales, a gradient estimate of parameters of neurons in the GLM, wherein the gradient estimate maximizes a learning objective of the GLM;
modifying the parameters of the GLM using the gradient estimate; and
providing a trained GLM with the modified parameters.

18. The non-transitory computer readable medium of claim 17, further comprising:
repeating the determining and the modifying over multiple iterations; and
generating the trained GLM upon completion of the multiple iterations.

19. The non-transitory computer readable medium of claim 17, further comprising:
determining rewards corresponding to the plurality of sampled rationales, wherein the rewards quantify whether the plurality of sampled rationales and questions in question-answer pairs would cause the GLM to generate corresponding answers; and
maximizing the learning objective of the GLM using the rewards.

20. The non-transitory computer readable medium of claim 17, wherein the trained GLM receives a question in a natural language and generates an answer.
